(19) United States
(12) Patent Application Publication
(10) Pub. No.: US 2024/0372378 A1
(43) Pub. Date: Nov. 7, 2024

(54) BATTERY PACKS WITH PARTIAL-POWER PROCESSING DC-DC CONVERTERS

(71) Applicant: Our Next Energy, Inc., Novi, MI (US)

(72) Inventors: Aaron Christopher Harkness, Howell, MI (US); Ashish Kumar, Santa Clara, CA (US)

(21) Appl. No.: 18/652,526

(22) Filed: May 1, 2024

Related U.S. Application Data
(60) Provisional application No. 63/499,695, filed on May 2, 2023.

(51) Int. Cl. H02J 7/00

(52) U.S. Cl. CPC H02J 7/0013; H02J 2207/20; H02J 2207/30

(57) ABSTRACT

Energy storage units and systems using batteries in combination with DC-DC converters are arranged in various parallel and/or series configurations to provide partial power processing through the DC-DC converters, and achieve low power loss and safe operation.

### FIELD OF THE DISCLOSURE

This disclosure relates to energy storage systems using partial-power processing DC-DC converters to reduce power losses during charging and discharging, and more particularly to energy storage units that can be combined in various serial and/or parallel configurations to provide design flexibility.

### BACKGROUND OF THE DISCLOSURE

Conventional energy storage units utilizing DC-DC converters to match output voltage with other storage units and/or loads, and/or to control power flow, have generally processed all charging and discharging power through the DC-DC converter. However, these arrangements lead to relatively high power losses and low system efficiencies.

### SUMMARY OF THE DISCLOSURE

Disclosed are various novel energy storage units having at least one battery stack and a DC-DC converter electrically connected with the battery stack such that most of the discharge and charge power transferred from or to the energy storage unit does not pass through the DC-DC converter, which leads to lower power losses and improved energy efficiency. The disclosed energy storage units can be arranged in various parallel and/or series configuration using contactors to achieve low loss in a safe manner.

In certain aspects, an energy storage unit includes a DC-DC converter having a positive input, a negative input, a positive output, and a negative output; and a first battery stack having a positive terminal electrically connected with the positive input of the DC-DC converter and with a positive terminal of a second battery stack, the first battery stack having a negative terminal electrically connected with the negative input of the DC-DC converter and with the positive output of the DC-DC converter, and the negative output of the DC-DC converter electrically connected with a negative terminal of the second battery stack.

In other aspects, an energy storage unit includes a DC-DC converter having a positive input, a negative input, a positive output, and a negative output; a first battery stack having a positive terminal electrically connected with the positive input of the DC-DC converter, and the first battery stack having a negative terminal electrically connected with the negative input of the DC-DC converter; a second battery stack having a negative terminal electrically connected with the positive output of the DC-DC converter, and the second battery stack having a positive terminal electrically connected with a positive terminal on a third battery stack; and the third battery stack having a negative terminal electrically connected with the negative output of the DC-DC converter.

In accordance with further aspects, an energy storage unit includes a DC-DC converter having a positive input, a negative input, a positive output, and a negative output; a first battery stack having a positive terminal electrically connected with the positive input of the DC-DC converter and with the positive terminal of a second battery stack, the first battery stack having a negative terminal electrically connected with the positive output of the DC-DC converter; and the second battery stack having a negative terminal electrically connected with the negative input of the DC-DC converter and with the negative output of the DC-DC converter.

In still further aspects, an energy storage system includes two or more energy storage units, each energy storage unit including a DC-DC converter having a positive input, a negative input, a positive output, and a negative output electrically connected or selectively connectable with a negative voltage bus, and a battery stack having a positive terminal electrically connected or selectively connectable with a positive voltage bus.

In accordance with additional aspects, an energy storage system includes two or more energy storage units, each energy storage unit including a DC-DC converter having a positive input, a negative input, a positive output, and a negative output, and a battery stack having a positive terminal and a negative terminal, at least one of the positive terminal and negative terminal electrically connected with at least one of the positive input, negative input, positive output, and a negative output of the DC-DC converter; wherein the energy storage systems are selectively electrically connectable in series through contactors.

### BRIEF DESCRIPTION OF THE DRAWINGS

FIG. 1 is a partial power processing architecture diagram for an energy storage unit in accordance with this disclosure.

FIG. 2 is a partial power processing architecture diagram for another energy storage unit in accordance with this disclosure.

FIG. 3 is a partial power processing architecture diagram for a third energy storage unit in accordance with this disclosure.

FIG. 4 is a schematic analysis of the power loss and efficiency of a conventional energy storage unit using full-power processing between two voltage sources.

FIG. 5 is a schematic analysis of the power loss and efficiency of an energy storage unit using partial-power processing between two voltage sources.

FIG. 6 graphically illustrate how moderate DC-DC converter efficiencies can enable high system efficiencies.

FIG. 7 shows the topology of a known isolated bidirectional DC-DC converter usable with any of the disclosed energy storage units.

FIG. 8 is a partial power processing architecture diagram for a plurality of energy storage units of FIG. 2 electrically connected in series.

FIG. 9 is a partial power processing architecture diagram for an energy storage unit having pluralities of individual batteries electrically connected in series.

FIG. 10 is a diagram showing a two-terminal partial power energy storage unit that can be electrically connected serially or in parallel with identical energy storage units to assemble an energy storage system.

FIG. 11 is a diagram showing another two-terminal partial power energy storage unit that can be electrically connected serially or in parallel with identical energy storage units to assemble an energy storage system.

FIG. 12 is a diagram showing an energy storage system comprising a plurality of energy storage units of FIG. 10 electrically connected in parallel.

FIG. 13 is a diagram showing an energy storage system comprising a plurality of energy storage units of FIG. 10 electrically connectable in parallel through contactors.

FIG. 14 is a diagram showing another energy storage system comprising a plurality of energy storage units of FIG. 10 electrically connectable in parallel through contactors.

FIG. 15 is a diagram showing an energy storage system comprising a plurality of energy storage units of FIG. 10 electrically connectable in series through contactors.

FIG. 16 is a diagram showing another energy storage system comprising a plurality of energy storage units of FIG. 10 electrically connectable in series through contactors.

### DETAILED DESCRIPTION

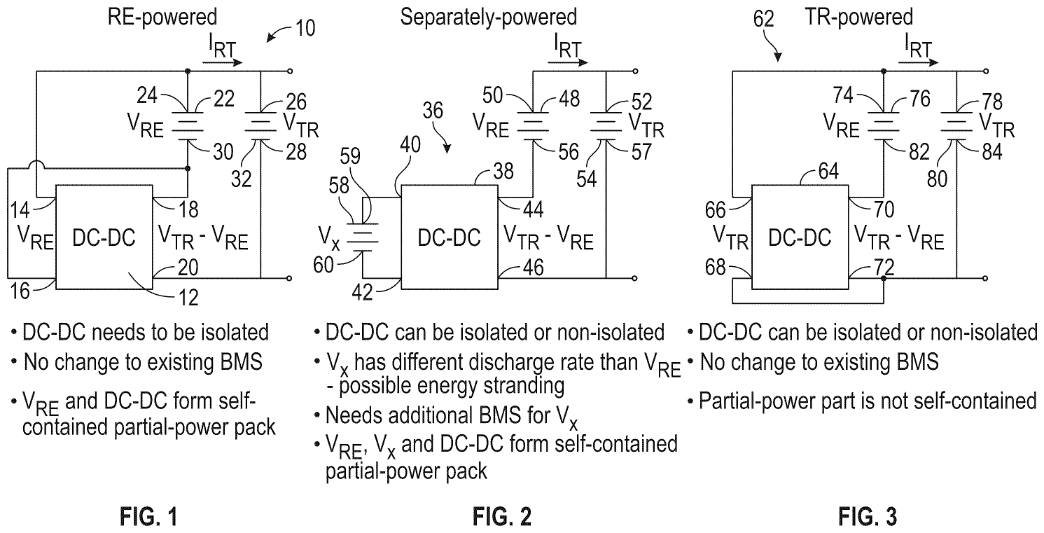

A partial power energy storage unit 10 is shown in FIG. 1. Unit 10 includes a DC-DC converter 12 having a positive input 14, a negative input 16, a positive output 18, and a negative output 20. A first battery stack 22 has a positive terminal 24 electrically connected with the positive input 14 of DC-DC converter 12 and with a positive terminal 26 of a second battery stack 28. The first battery stack has a negative terminal 30 electrically connected with the negative input of DC-DC converter 12 and with the positive output 18 of DC-DC converter 12. Negative output 20 of DC-DC converter 12 is electrically connected with a negative terminal 32 of second battery stack 28. DC-DC converter 12 is preferably bidirectional and isolated. Battery stacks 22 and 28 can individually be either a single battery (one or a collection of cells packaged as a unit having a single positive terminal and a single negative terminal) or a plurality of batteries electrically connected serially and/or in parallel. Energy storage units 10 can be arranged in combination with one or more identical (or different) energy storage units either serially or in parallel. The first and second battery stacks can have the same or different chemistries. Among the various embodiments described and claimed, the batteries having different chemistries include energy storage systems having traction batteries using a first cell chemistry (e.g., lithium iron phosphate, LiFePO₄) and range extender batteries using a second cell chemistry (e.g., anode-less lithium metal batteries). Such systems are described in United States Publication No. US2022/0111759, published Apr. 14, 2022, which is incorporated herein, in its entirety, by reference.

Another partial power energy storage unit 36 is shown in FIG. 2. Unit 36 includes a DC-DC converter 38 having a positive input 40, a negative input 42, a positive output 44 and a negative output 46. A first battery stack 48 has a positive terminal 50 electrically connected with a positive terminal 52 of a second battery stack 54. First battery stack 48 has a negative terminal 56 electrically connected with positive output 44 of DC-DC converter 38. Second battery stack 54 has a negative terminal 57 electrically connected with negative output 46 of DC-DC converter 38. A third battery stack 58 has a positive terminal 59 electrically connected with positive input 40 of DC-DC converter 38 and a negative terminal 60 electrically connected with negative input 42 of DC-DC converter 38. The DC-DC converter can be isolated or non-isolated and is preferably bidirectional. Battery stacks 48, 54 and 58 can individually be either a single battery or a plurality of batteries electrically connected serially and/or in parallel. Energy storage units 36 can be arranged in combination with one or more identical (or different) energy storage units either serially or in parallel. Battery stacks 48, 54 and 58 can have the same or different battery chemistries.

A third partial power energy storage unit 62 is shown in FIG. 3. Unit 62 includes a DC-DC converter 64 having a positive input 66, a negative input 68, a positive output 70, and a negative output 72. A first battery stack 74 has a positive terminal 76 electrically connected with positive input 66 and with a positive terminal 78 of a second battery stack 80. The first battery stack 74 has a negative terminal 82 electrically connected with positive output 70. Second battery stack 80 has a negative terminal 84 electrically connected with negative input 68 and with negative output 72. DC-DC converter 64 can be isolated or non-isolated and is preferably bidirectional. Battery stacks 74 and 80 can individually be either a single battery or a plurality of batteries electrically connected serially and/or in parallel. Units 62 can be arranged in combination with one or more identical (or different) energy storage units either serially or in parallel. Battery stack 74 and 80 can employ the same or different chemistries.

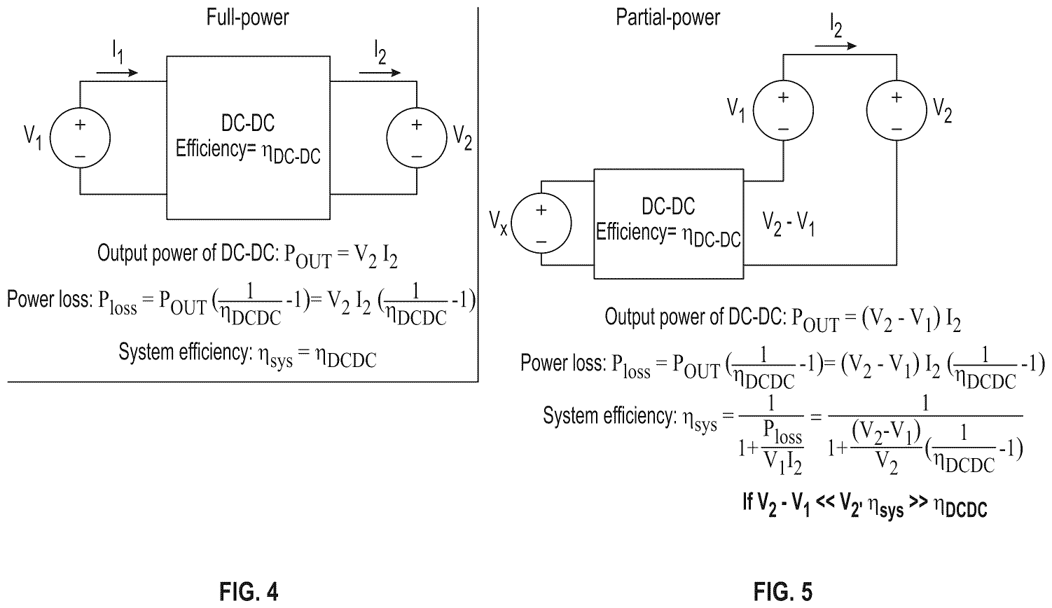

FIG. 4 is a schematic analysis of the power loss and efficiency of full-power processing through a DC-DC converter, and FIG. 5 is a schematic analysis of the power loss and efficiency of partial-power processing. A comparison shows the inherent improvement in efficiency and reduced power loss of the partial-power system.

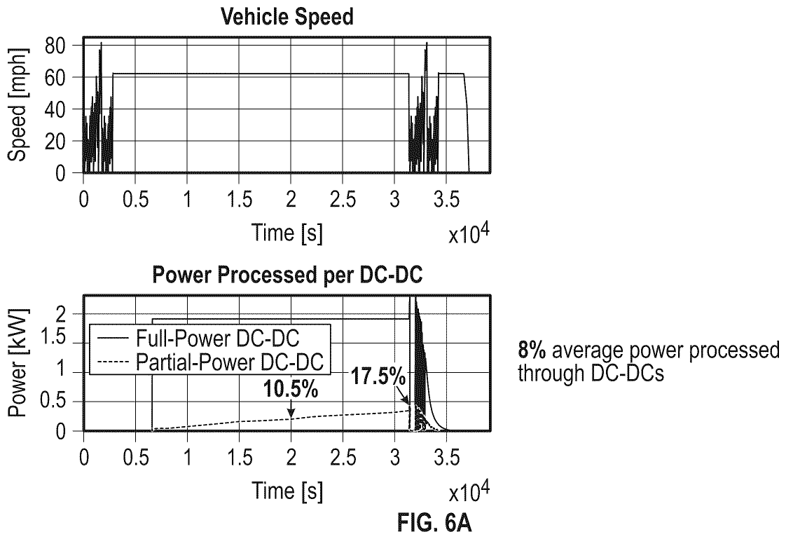

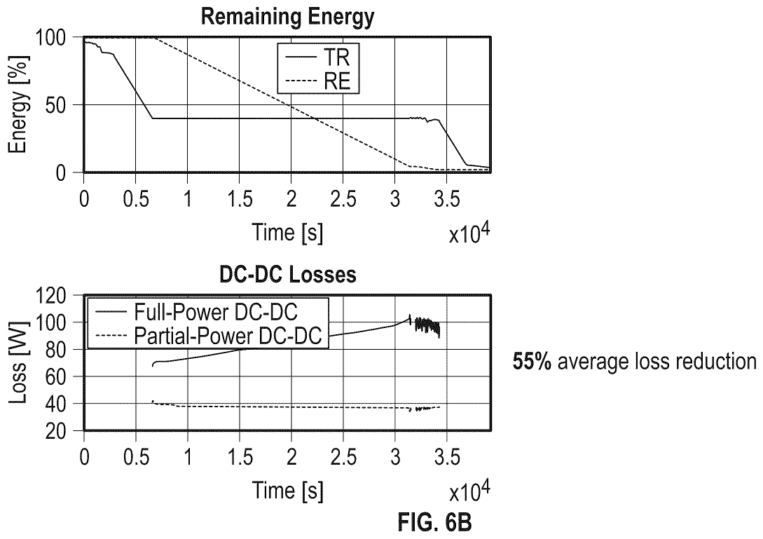

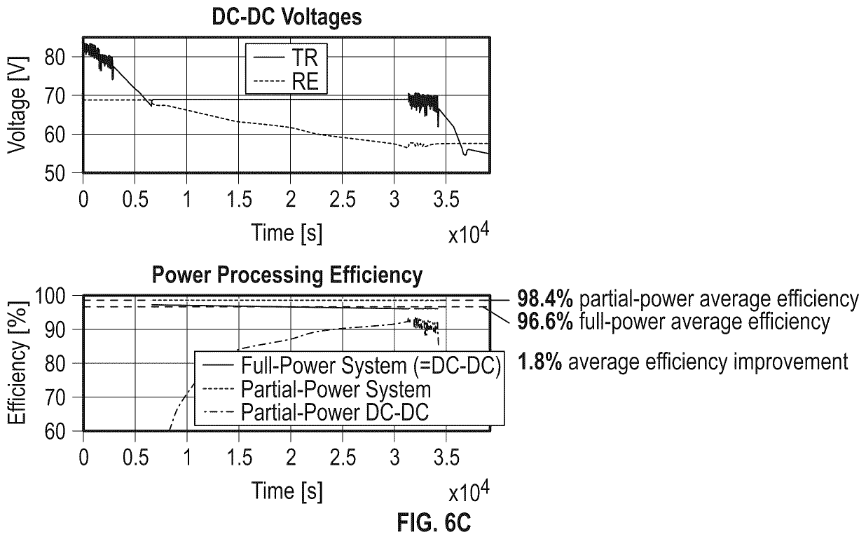

FIG. 6 graphically illustrates how moderate DC-DC converter efficiencies can provide high system efficiencies. In particular, it is shown that the average power loss for partial-power DC-DC converter processing is 55% less than for full-power DC-DC converter processing.

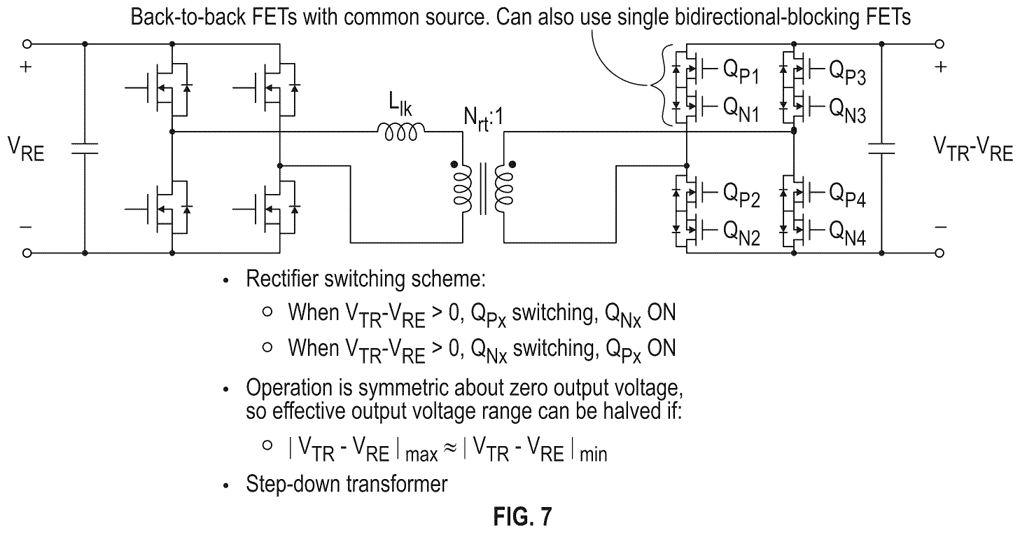

FIG. 7 shows the topology of a standard dual active bridge DC-DC converter with a bipolar-voltage capable rectifier that is useful in any of the disclosed energy storage units and systems.

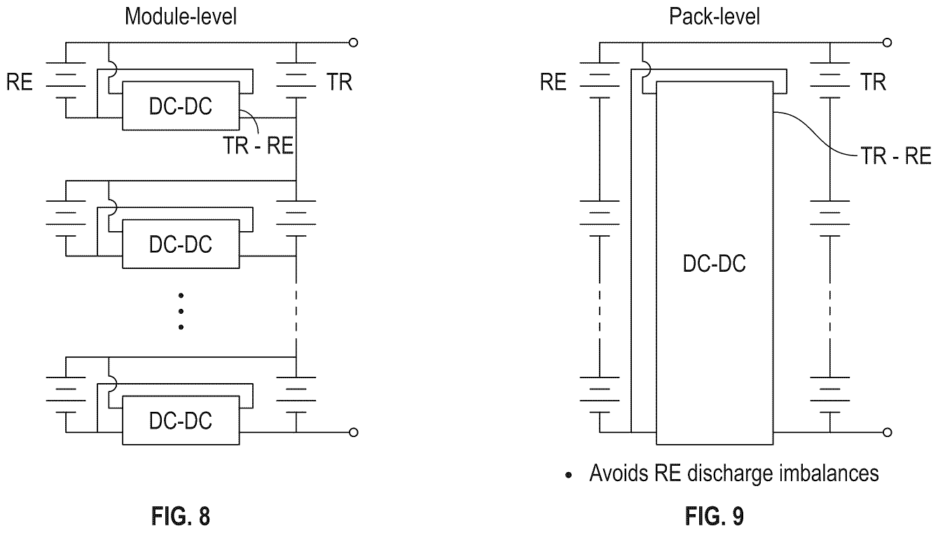

FIG. 8 illustrates how the energy storage units shown in FIG. 1 can be electrically connected in series to provide a high voltage system.

FIG. 9 shows that the single batteries shown for the energy storage unit of FIG. 1 can be replaced with a battery stack comprising a plurality of individual batteries electrically connected in series. Additionally, the batteries shown in FIG. 1 can be replaced with any plurality of batteries electrically connected serially, in parallel, or a combination of serial and parallel connections. As used in this description and in the appending claims, the term “battery stack” encompasses a single battery or any combination of batteries connected serially and/or in parallel.

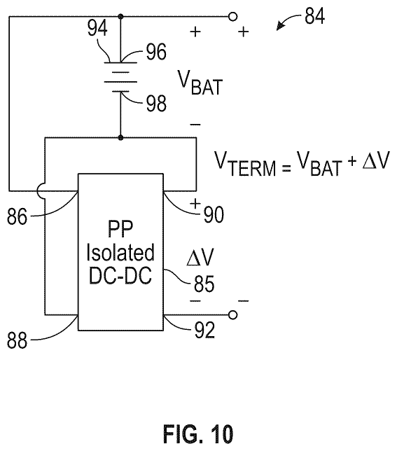

FIG. 10 shows a two-terminal partial power storage unit 84 that can be connected with identical (or different) power storage units, either in series or in parallel, to assemble an energy storage system. Unit 84 includes a DC-DC converter 85 having a positive input 86, a negative input 88, a positive output 90 and a negative output 92; and a battery stack 94. A positive terminal 96 of battery stack 94 is electrically connected with the positive input 86, and a negative terminal 98 of battery stack 94 is electrically connected with the negative input 88 and the positive output 90 of converter 85. The positive terminal of battery stack 94 and the negative output 92 of DC-DC converter 85 can be interfaced with a load, a high voltage bus, another unit 84 (or a different energy unit), or supplemental battery stack. Unit 84 matches the battery stack voltage to a desired terminal voltage, which can be dictated by other energy storage units, loads, etc. Unit 84 also controls the power drawn from battery stack 94, processing a fraction of the power through the DC-DC converter 85, providing lower power loss and greater efficiency.

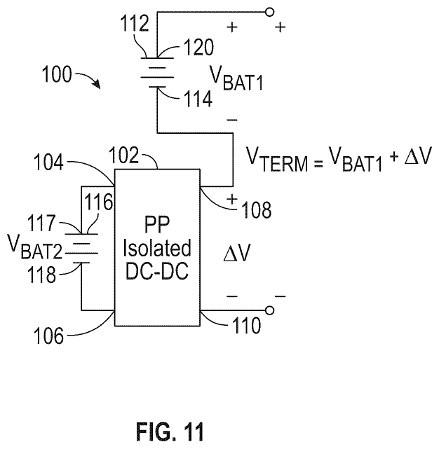

FIG. 11 shows another two-terminal partial power storage unit 100 that can be connected with identical (or different) power storage units, either in series or in parallel, to assemble an energy storage system. Unit 100 includes DC-DC converter 102 having positive input 104, negative input 106, positive output 108, and negative output 110; and battery stack 112. A negative terminal 114 of battery stack 112 is electrically connected with positive output 108 of DC-DC converter 102. A second battery stack 116 has a positive terminal 117 electrically connected with positive input 104, and a negative terminal 118 electrically connected with negative input 106 of DC-DC converter 102. Positive terminal 120 of battery stack 112 and negative output 110 of DC-DC converter 102 can be interfaced with a load, a high voltage bus, another unit 100 (or a different energy unit), or supplemental battery stack. Unit 100 performs functions of matching battery stack 112 voltage to a desired terminal voltage, and controls power drawn from battery stack 112, processing a fraction of the power through the DC-DC converter 102, providing lower power loss and greater efficiency.

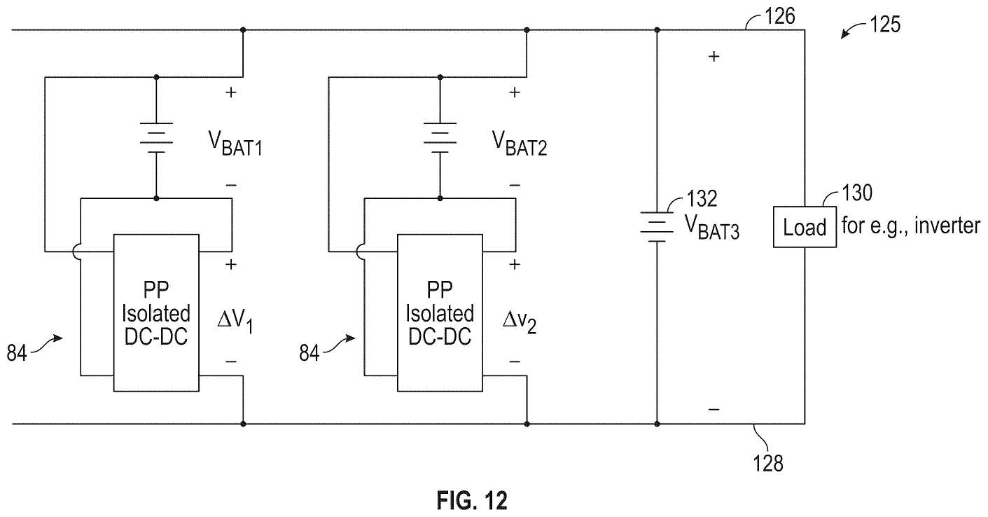

An energy storage system 125 comprising a plurality of energy storage units 84 electrically connected in parallel is shown in FIG. 12. Any number of units 84 can be connected with high voltage positive bus 126 and negative bus 128 from which a load 130 is powered. A supplemental battery stack 132 can be electrically connected in parallel with units 84.

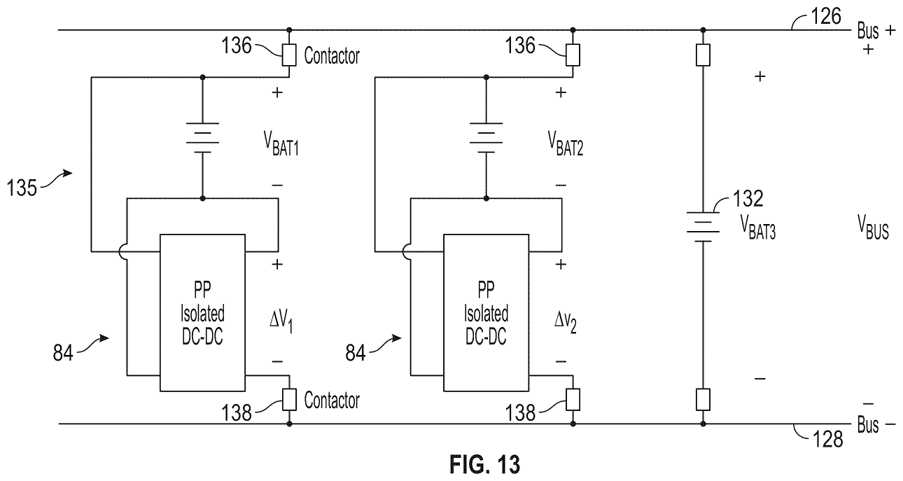

FIG. 13 shows an energy storage system 135 that is generally identical to energy storage system 125 except that rather than connecting the terminals of units 84 directly to positive bus 126 and negative bus 128, units 84 are connectable through contactors 136, 138 to facilitate safe joining of units 84 in parallel. Prior to contactor closure, the bus voltage (V_{BUS}) is measured and the output of individual DC-DC converters is adjusted so that the series sum of DC-DC output voltage plus the individual battery stack voltage (V_{BATx}+ΔVₓ) matches the bus voltage. Once the voltage match is within a tolerable range, the contactors are safely closed and the power drawn from units 84 is actively controlled with partial-power processing. This arrangement is particularly suited for multi-chemistry pack paralleling (i.e., when the battery stack chemistry is different for different units 84 and/or supplemental battery stack 132).

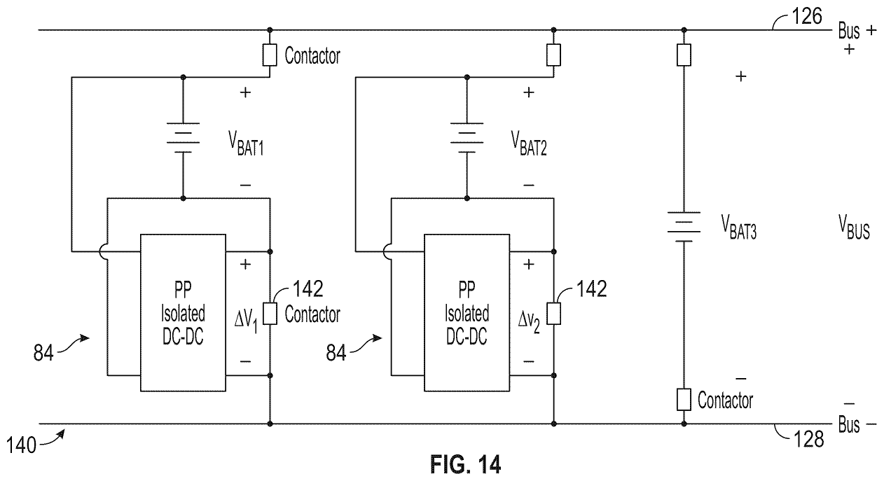

FIG. 14 shows an energy storage system 140, generally identical to system 135, except rather than having the negative output from the DC-DC converter connectable to negative bus 128 through contactor 138, the positive output and negative output of the DC-DC converters are connectable through contactors 142. Prior to contactor closure, bus voltage is measured and the output of individual DC-DC converters is adjusted so that the series sum of DC-DC output voltage plus the individual battery stack voltage (V_{BATx}+ΔVₓ) matches the bus voltage (V_{BUS}). Once the voltage match is within a tolerable range, the contactors 136 are safely closed, and the units 84 and supplemental pack 132 can charge and discharge each other with partial-power processing until the battery stack voltages of each unit 84 and the battery stack voltage of supplemental pack 132 are well matched. At this point the contactors 142 are safely closed, bypassing the DC-DC converters such that the DC-DC losses are eliminated, with the tradeoff that power drawn from units 84 is no longer actively controlled. This arrangement is particularly suited for single-chemistry pack paralleling (i.e., when the battery chemistry is the same for each unit 84 and/or supplemental battery stack 132).

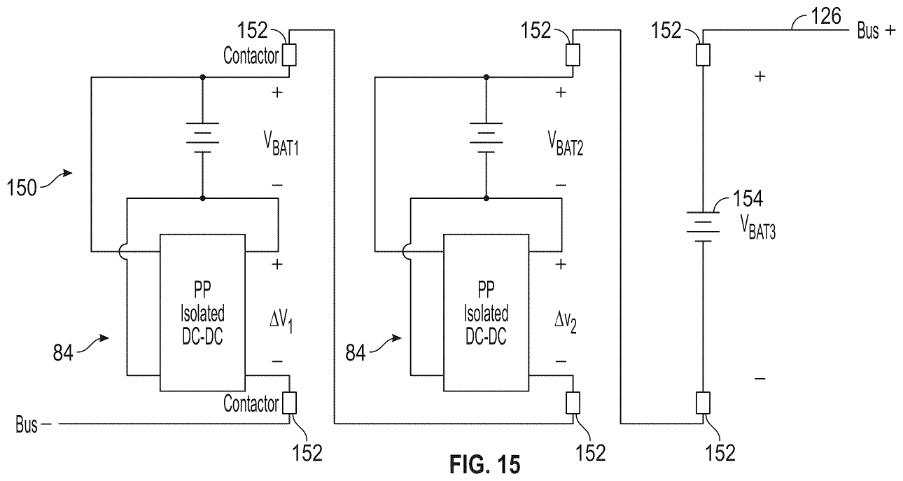

FIG. 15 shows an energy storage system 150 having a plurality of energy storage units 84 electrically connectable in series through contactors 152. Optionally, supplemental battery stack(s) 154 can be electrically connected in series with units 84. Prior to contactor 152 closure, the bus voltage is measured, and the output of individual DC-DC converters is adjusted so that the series sum of DC-DC converter output voltage plus battery stack voltage matches that of the bus voltage. Once the voltage match is within a predetermined tolerance, the contactors can be safely closed and the units can be connected in series for charging or discharging with partial-power processing. This arrangement is well suited for multi-chemistry pack series connections and fast charging.

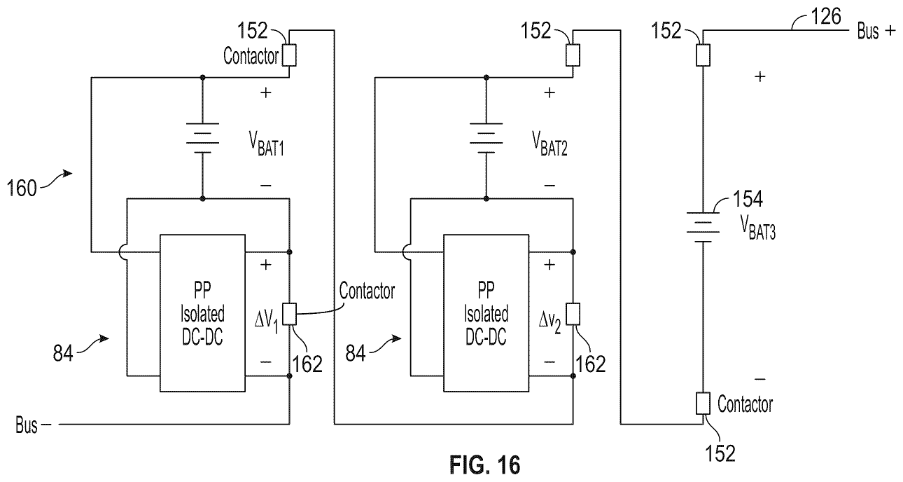

FIG. 16 shows an energy storage system 160, generally identical to system 150, except rather than having the negative output from the DC-DC converters being electrically connectable with the negative bus (at one end of the series) or the positive terminal of another unit 84 through contactors 152, the positive output and negative output of each DC-DC converter is connectable through contactors 162. Prior to contactor 162 closure, bus voltage is measured and the output voltage of individual isolated DC-DC converters is adjusted so that the series sum of the DC-DC converter output voltage plus battery stack voltage matches that of the bus voltage. The individual packs can then be safely charged or discharged with an external source or load with partial-power processing until voltages are well matched, at which time the contactors 162 can be closed so that the DC-DC converters are bypassed, eliminating DC-DC losses. This allows units 84 to be electrically connected in series, but foregoes power flow control for individual units 84. This arrangement is well suited for single chemistry series connection and fast charging.

While the present invention is described herein with reference to illustrated embodiments, it should be understood that the invention is not limited hereto. Those having ordinary skill in the art and access to the teachings herein will recognize additional modifications and embodiments within the scope thereof. Therefore, the present invention is limited only by the claims attached herein.

1. An energy storage system, comprising:
two or more energy storage units electrically connected serially or in parallel, each energy storage unit including a DC-DC converter having a positive input, a negative input, a positive output, and a negative output electrically connected or selectively connectable with a negative voltage bus,
each energy storage unit including a battery stack having a positive terminal electrically connected or selectively connectable with a positive voltage bus, and
wherein the positive terminal of the battery stack of each energy storage unit is electrically connected with the positive input of the DC-DC converter, and a negative terminal of the battery stack of each energy storage unit is connected with the negative input of the DC-DC converter and with the positive output of the DC-DC converter.

2. (canceled)

3. (canceled)

4. The energy storage system of claim 1, further comprising at least one supplemental battery stack energy storage unit having a positive terminal connected or selectively connectable with the positive voltage bus, and a negative terminal connected or selectively connectable with the negative voltage bus.

5. The energy storage system of claim 1, wherein the energy storage units and/or the supplemental battery stack(s) are selectively connectable to the positive voltage bus and the negative voltage bus through contactors.

6. The energy storage system of claim 1, wherein the energy storage units and/or the supplemental battery stack(s) are selectively connectable to the positive voltage bus through contactors, and the positive output of the DC-DC converter and the negative output of the DC-DC converter for each energy storage unit is selectively connectable through a contactor.

7. An energy storage system, comprising:
two or more energy storage units, each energy storage unit including a DC-DC converter having a positive input, a negative input, a positive output, and a negative output, and
each energy storage unit including a battery stack having a positive terminal and a negative terminal, at least one of the positive terminal and negative terminal electrically connected with at least one of the positive input, negative input, positive output, and a negative output of the DC-DC converter;
wherein the energy storage units are selectively electrically connectable in series through contactors.

8. The energy storage system of claim 7, further comprising at least one supplemental battery electrically connectable in series with the energy storage units through contactors.

9. The energy storage system of claim 7, wherein the positive terminal of the battery stack of each energy storage unit is electrically connected with the positive input of the DC-DC converter, and a negative terminal of the battery stack of each energy storage unit is connected with the negative input of the DC-DC converter and with the positive output of the DC-DC converter.

10. The energy storage system of claim 9, wherein the positive output of the DC-DC converter and the negative output of the DC-DC converter for each energy storage unit is selectively connectable through a contactor.

11. A partial power energy storage unit, comprising:
a DC-DC converter having a positive input, a negative input, a positive output, and a negative output;
a first and a second battery stack;
an optional third battery stack;
the first battery stack having a negative terminal electrically connected with the positive output of the DC-DC converter;
the second battery stack having a negative terminal electrically connected with the negative output of the DC-DC converter;
the positive input of the DC-DC converter being electrically connected to positive terminals of the first battery stack and the second battery stack, or to a positive terminal of the optional third battery stack; and
the negative input of the DC-DC converter being electrically connected to the negative terminal of the first battery stack, the negative terminal of the second battery stack, or a negative terminal of the third battery stack.

12. The energy storage unit of claim 11, wherein the DC-DC converter is an isolated bidirectional DC-DC converter.

13. The energy storage unit of claim 11, wherein the first battery stack and/or the second battery stack comprises a plurality of individual batteries electrically connected serially or in parallel.

14. The energy storage unit of claim 11 arranged in combination with one or more identical energy storage units, wherein the each energy storage unit is electrically connected with terminals of other energy storage units either serially or in parallel.

15. The energy storage system of claim 14, further comprising at least one supplemental battery stack arranged serially or in parallel with the energy storage units.

16-25. (canceled)
